(19) United States
(12) Patent Application Publication
(10) Pub. No.: US 2025/0351246 A1
(43) Pub. Date: Nov. 13, 2025

(54) LED DECORATIVE LIGHT WITH CONTROLLABLE FLASHING BUBBLES

(71) Applicant: HANGZHOU YUN LED CHIP PHOTOELECTRICITY TECH. CO., LTD., Hangzhou (CN)

(72) Inventors: Yinghan YANG, Hangzhou (CN); Zixun ZHANG, Hangzhou (CN)

(73) Assignee: HANGZHOU YUN LED CHIP PHOTOELECTRICITY TECH. CO., LTD., Hangzhou (CN)

(21) Appl. No.: 19/274,598

(22) Filed: Jul. 20, 2025

Related U.S. Application Data
(63) Continuation of application No. PCT/CN2024/070275, filed on Jan. 3, 2024.

(30) Foreign Application Priority Data
Feb. 27, 2023 (CN) 202310170033.X

(51) Int. Cl. H05B 45/44; H05B 47/17

(52) U.S. Cl. CPC H05B 45/44; H05B 47/17

(57) ABSTRACT

The present invention discloses an LED decorative light with controllable flashing bubbles, including: a controller and a light string. The positive terminal and negative terminal of the controller are connected to the light string, where the controller supplies power to the light string through the positive and negative terminals while loading control signals on either/both the positive terminal and negative terminal. The light string includes a plurality of LEDs and a plurality of controllable flashing bubbles, with the controllable flashing bubbles receiving the control signals to achieve adjustable flashing effects. By interspersing controllable flashing bubbles among constant-on LEDs and enabling them to receive control signals loaded by the controller at power output terminals, the invention realizes an LED decorative light whose flashing functions or patterns can be controller-adjusted.

### CROSS-REFERENCE TO RELATED APPLICATIONS

The present application is a continuation of International Patent Application No. PCT/CN2024/070275 filed on Jan. 3, 2024, which claims priority to Chinese Patent Application No. 202310170033.X filed on Feb. 27, 2023. The disclosures of the above-referenced applications are hereby incorporated by reference in their entirety.

### BACKGROUND

Current LED decorative lights with flashing bubbles on the market achieve a star-like random twinkling effect by interspersing flashing bubbles among conventional light-emitting diodes (LEDs). This innovation addresses the limitation of ordinary LED decorative lights that only provide static illumination.

In existing LED decorative lights with flashing bubbles, the flashing bubbles are controlled by driver chips to blink in fixed patterns. However, the controller of such lights cannot adjust the flashing bubbles to achieve effects such as varying flash frequencies or different blinking modes. As disclosed in Chinese Patent No. CN203431704U, an IC chip-controlled LED Christmas light string belongs to the technical field of decorative lighting. The Christmas light string comprises a transformer, a controller, a constant-illumination LED branch, and a controllable LED branch. The output terminal of the transformer is connected to the input terminal of the controller, while the output terminal of the controller is respectively connected to both the constant-illumination LED branch and the controllable LED branch. The IC chip-controlled LED Christmas light string features a simple structure and rational design. Through IC module control, it achieves point-by-point control of LEDs requiring illumination pattern changes in the controllable LED branch, enabling rich lighting effects without requiring special LEDs. However, this design necessitates the physical separation of the constant-illumination and controllable LED branches, requiring them to be twisted together, which results in a complex light string structure. Chinese Patent No. CN205807040U discloses an adjustable flashing light string and cherry blossom tree device, comprising: a positive line for receiving power from a voltage source; a negative line connected to ground; multiple LED light strings connected in parallel between the positive and negative lines, each containing several flashing bulbs and constant-on bulbs connected in series; a control chip connected to either the positive or negative line for switching the entire circuit. The utility patent employs a single control chip for operation. During development, software simulation is used to determine the required control methods and functionalities, allowing for clear visualization of effects and implementation. The control scheme offers flexible and versatile operation modes, enabling: switching between constant-on mode and flashing mode individually; combined operation of both constant-on and flashing modes. However, the design cannot achieve controller-adjustable flashing functions or programmable flashing patterns through either the main controller or the control chip.

Therefore, developing LED decorative lights with controller-adjustable flashing features remains a key research focus in this technical field.

### SUMMARY

The present invention relates to the field of LED decorative lights, and more particularly to an LED decorative light with controllable flashing bubbles.

The purpose of the present invention is to provide an LED decorative light with controllable flashing bubbles. By interspersing controllable flashing bubbles among constant-on LEDs, where the controllable flashing bubbles receive control signals loaded at the power terminals of a controller, an LED decorative light is realized whose flashing function or flashing pattern can be controlled by the controller.

An LED decorative light with controllable flashing bubbles, comprises:
a controller and a light string;
a positive terminal and a negative terminal of the controller are connected to the light string, wherein the controller supplies power to the light string through the positive terminal and the negative terminal, and loads control signals on the positive terminal and/or the negative terminal;
the light string comprises a plurality of LEDs and a plurality of controllable flashing bubbles, with the plurality of LEDs and the plurality of controllable flashing bubbles being in the same current path;
the controllable flashing bubbles receive the control signals to achieve controllable flashing effects.

It should be understood that loading control signals on the positive terminal and/or the negative terminal means: the control signals may be loaded solely on the positive terminal, or solely on the negative terminal, or loaded on both the positive terminal and negative terminal in combination. Loading control signals on the positive terminal and/or the negative terminal means loading the control signals at the power output terminals.

It should be understood that the plurality of LEDs and plurality of controllable flashing bubbles being in the same current path may be: the plurality of LEDs and plurality of controllable flashing bubbles connected in parallel to form the same current path; or part of the plurality of LEDs and part of the plurality of controllable flashing bubbles connected in parallel to form a parallel group, with such parallel groups connected in series to form the same current path; or part of the plurality of LEDs and part of the plurality of controllable flashing bubbles connected in series to form a series group, with such series groups connected in parallel to form the same current path.

As a preferred embodiment, the controllable flashing bubble comprises:
a driver chip and a controlled LED, wherein the driver chip receives the control signal and controls the controlled LED to achieve the controllable flashing effect.

It should be understood that the controlled LED may be: a single warm white LED; a single cool white LED; or a plurality of LEDs of different primary colors, such as a combination of red LED, green LED, and blue LED forming an RGB LED. The controlled LED may be driven by a single output port of the driver chip or by multiple output ports.

As a preferred embodiment, the driver chip performs an operation triggered by the control signal and drives the controlled LED based on the operation result.

As a preferred embodiment, the plurality of LEDs operates in a constant-on mode. The constant-on mode LEDs may be cool white LEDs, warm white LEDs, or LEDs of other colors. It should be understood that the constant-on mode LEDs may be controlled by the controller to: achieve brightness/darkness flashing, gradually increase brightness from dark, gradually decrease brightness from bright, or maintain a preset brightness level.

Furthermore, the plurality of LEDs are ordinary light-emitting diodes without built-in driver chips.

As a preferred implementation, the control signal includes an address signal, and the driver chip receives the address signal and compares it with its own address code; when the received address signal matches the driver chip's address code, the driver chip executes the control signal.

It should be understood that: the controllable flashing bubbles may be arranged either sequentially or randomly according to the driver chip addresses.

It should be understood that, the plurality of LEDs and controllable flashing bubbles may be configured to form the light string in any of the following topologies: fully parallel connection, fully series connection, parallel connection first followed by series connection (parallel-series), or series connection first followed by parallel connection (series-parallel). The LEDs and controllable flashing bubbles may be assembled at either: fixed proportional intervals, or random proportional intervals.

As a preferred implementation, the operation is an arithmetic operation, a logical operation, or a combination of arithmetic and logical operations.

As a preferred implementation, the driver chip performs a pulse-counting operation based on the control signal.

As an alternative operation method, the driver chip performs encoding or decoding operations on the control signal, wherein the pulse width (high or low level duration) of the control signal corresponds to encoded information.

For the encoding or decoding operations, the encoded information is represented by different high-level durations, different low-level durations, or a combination of different high-level durations and different low-level durations in the control signal.

As another alternative operation method, the driver chip performs modulation or demodulation operations based on current or voltage frequency, and drives the controlled LED according to the modulation or demodulation results.

As a preferred implementation, the controller comprises a controllable switch module, and the control signal is loaded via the controllable switch module.

As a preferred implementation for loading the control signal, the controllable switch module comprises a first controllable switch and an intermediate voltage module; when the first controllable switch is turned off, the intermediate voltage module generates a second voltage level, and the control signal is loaded by switching between the power supply voltage level and the second voltage level. The second voltage level is higher than the reference ground but lower than the power supply level.

As an alternative implementation, the control signal is loaded by controlling the turn-on and turn-off of the controllable switch module. It should be understood that during this process, formed by the switching actions of the controllable switch module, while receiving power supply, the controllable flashing bubbles simultaneously receive: pulse signals, rising-edge signals, or falling-edge signals.

As another alternative, the controllable switch module is a first controllable switch, and the control signal is loaded by controlling the turn-on and turn-off of the first controllable switch.

As yet another alternative, the controllable switch module comprises:
a second controllable switch, a third controllable switch, and a current-limiting resistor;
the second controllable switch comprises a control terminal electrically connected to the control circuit, an input terminal serving as the input of the switch module, and an output terminal connected to ground;
the third controllable switch comprises a control terminal electrically connected to the control circuit, and an output terminal connected to ground;
the current-limiting resistor connects between the input terminal of the second controllable switch, and the input terminal of the third controllable switch.

The present invention realizes an LED decorative light whose flashing function or flashing pattern can be controlled by the controller, by arranging controllable flashing bubbles among constant-on LEDs and having the flashing bubbles receive control signals loaded at the controller's power output terminals.

### BRIEF DESCRIPTION OF DRAWINGS

To more clearly illustrate the embodiments of the disclosure, the following is a brief description of the drawings, which are for illustrative purpose only. For those of ordinary skills in the art, other drawings of other embodiments can become apparent based on these drawings.

FIG. 1 illustrates an LED decorative light with controllable flashing bubbles in full parallel configuration according to Embodiment I;

FIG. 2 illustrates the controllable flashing bubbles in Embodiment I;

FIG. 3 illustrates the driver chip for controllable flashing bubbles in Embodiment I;

FIG. 4 illustrates the controller in Embodiment I;

FIG. 5 illustrates the control signal diagram in Embodiment I;

FIG. 6 illustrates an LED decorative light with controllable flashing bubbles in full parallel configuration according to Embodiment II;

FIG. 7 illustrates both the controllable flashing bubbles and their driver chips in Embodiment II;

FIG. 8 illustrates the control signals loaded on power lines in Embodiment II; and

FIG. 9 illustrates another representation of control signals loaded on power lines in Embodiment II.

### DETAILED DESCRIPTION

The present invention will now be described in further detail with reference to the accompanying drawings and specific embodiments.

### Embodiment I

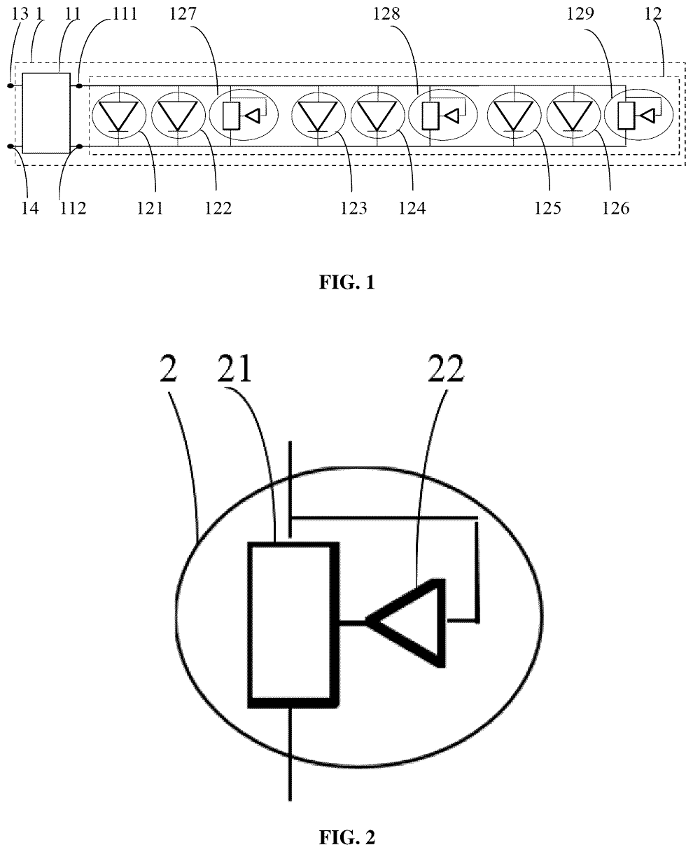

As shown in FIG. 1, the fully parallel-configured LED decorative light (1) with controllable flashing bubbles comprises:
a controller (11) and a light string (12);

The controller supplies power to the light string (12) through the positive terminal (111) and negative terminal (112), while loading control signals on the negative terminal (112);

The light string (1) includes: 6 ordinary cool-white LEDs (121, 122, 123, 124, 125, and 126) and 3 controllable flashing bubbles (127, 128, and 129), all connected within the same parallel current path.

The controller connects to a 3.3V power supply positive terminal at input (13), and a 3.3V power supply negative terminal at input (14).

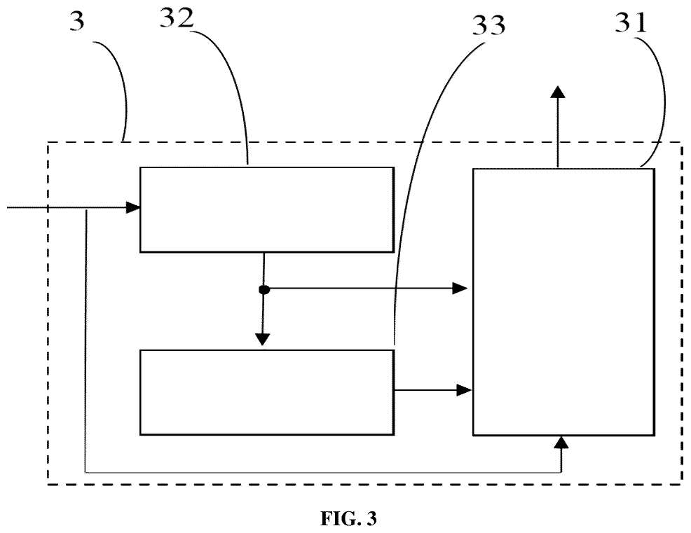

As illustrated in FIG. 2 showing the structure of controllable flashing bubble (2), all flashing bubbles (127, 128, 129) in this embodiment adopt this configuration, which comprises a driver chip (21) and a controlled warm-white LED (22). The driver chip (21) receives control signals and regulates the controlled warm-white LED (22) to switch between ON and OFF states. As shown in FIG. 2, the output terminal of driver chip (21) connects to the cathode of controlled warm-white LED (22), the power supply terminal of driver chip (21) connects to the anode of controlled warm-white LED (22). When the driver chip's output terminal conducts or outputs LOW level, current flows through the controlled warm-white LED (22), causing illumination; when the driver chip's output terminal cuts off or outputs HIGH level, current is blocked, turning OFF the controlled warm-white LED (22).

Driver chip 21 adopts the structure shown in FIG. 3. As shown in FIG. 3, the driver chip 3 comprises: control signal trigger operation unit (31) which performs computations based on control signals input through power lines and outputs computation results; charging unit (32) which provides power supply level to the control signal trigger operation unit (31) according to input control signals, charges when control signal is at HIGH level, and discharges when control signal is at LOW level; initialization unit (23) which initializes the control signal trigger operation unit (31) based on the power supply level provided by charging unit (32).

The control signal trigger operation unit (31) performs modulo-2 pulse counting operations on the control signals: count result is equal to 1 (HIGH level) upon receiving the first pulse, the controlled warm-white LED (22) is drove to OFF state; count result is equal to 0 (LOW level) upon receiving the second pulse, the controlled warm-white LED (22) is drove to ON state.

The driver chip (3) in this embodiment does not incorporate an address unit, and the control signals contain no address information. All three controllable flashing bubbles (127, 128, 129) operate in synchronized mode, being uniformly controlled by the same control signals.

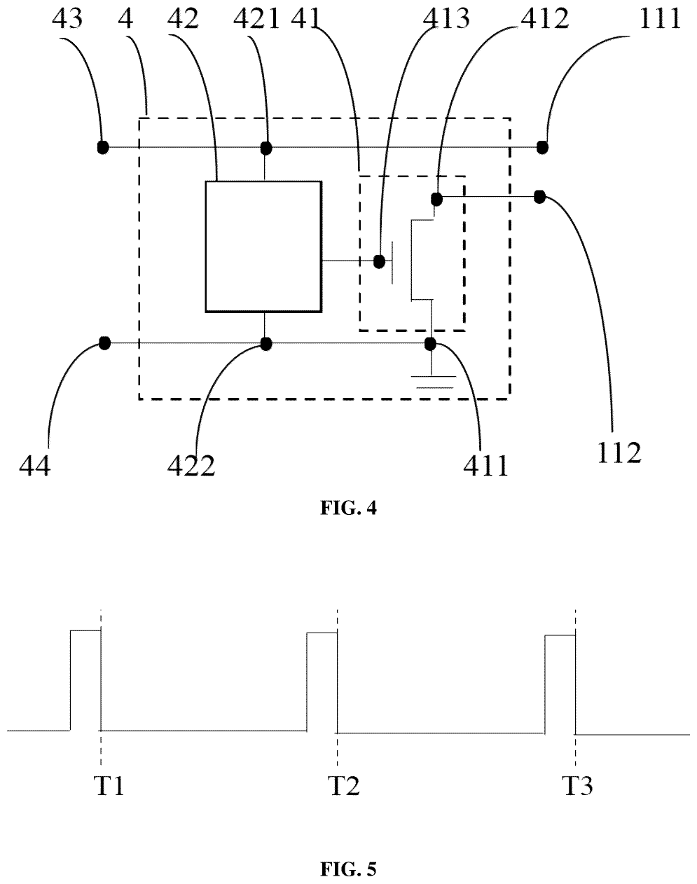

As shown in FIG. 4, the controller 4 (the controller 11 in this embodiment adopts the structure shown in FIG. 4) includes an NMOS 41 as a controllable switch: the drain 411 of the NMOS is grounded, the source 412 serves as the negative terminal 112 of the controller 4, and the gate 413 is connected to the microprocessor 42; the input terminal 43 of the controller 4 is connected to the 3.3V positive power supply and serves as the positive terminal 111 of the controller, the input terminal 44 of the controller 4 is connected to the 3.3V negative power supply and shares ground connection with the drain 411 of the NMOS; the power supply terminal 421 of the microprocessor 42 is connected to the input terminal 43 of the controller 4, and the ground terminal 422 of the microprocessor 42 is connected to the input terminal 44 of the controller 4, which is connected to the 3.3V negative power supply. By running software programs on the microprocessor 42, the switching of NMOS 41 is controlled to generate control signals, which are loaded onto the negative power line.

The timing diagram of the control signals at the negative terminal 112 of the controller 11 in this embodiment relative to the reference ground is shown in FIG. 5, where the pulse high level is 3.3V and the low level is 0V (reference ground level). At time T1, after the arrival of the first pulse of the control signal, the control signal trigger operation unit 31 of the driver chip 3 in this embodiment performs a modulo-2 counting operation on the control signal, resulting in a count of 1 (high level), which drives the controlled warm white LED 22 to be off; at time T2, that is, after an interval of (T2−T1), the second pulse of the control signal arrives, resulting in a count of 0 (low level), which drives the controlled warm white LED 22 to be on; at time T3, the third pulse of the control signal arrives, resulting in a count of 1 (high level), which drives the controlled warm white LED 22 to be off. From the control signal timing diagram in FIG. 5, it can be easily understood that by controlling the duration of (T2−T1), the duration for which the controlled warm white LED 22 is off can be controlled; by controlling the duration of (T3−T2), the duration for which the controlled warm white LED 22 is on can be controlled. Therefore, by controlling (T3−T2) and (T2−T1), different frequency flashing effects can be achieved, and further, dynamic changes in the flashing frequency can be realized by running software programs on the microprocessor 42. In this embodiment, the pulse high level shown in FIG. 5 is less than 1 ms and greater than 10 ns, which is imperceptible to the human eye and does not affect the decorative lights.

### Embodiment II

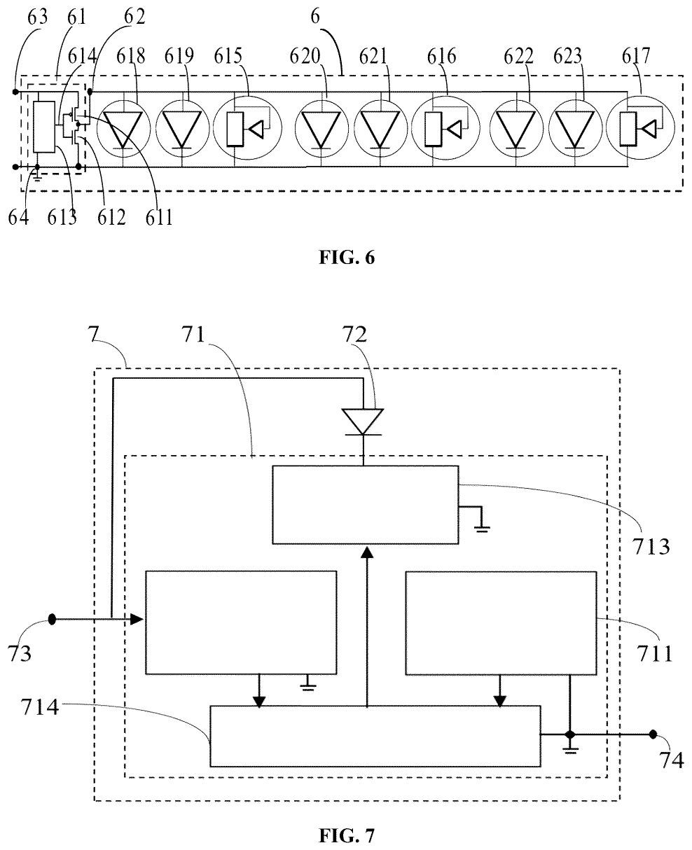

As shown in FIG. 6, the LED decorative light 6 with controllable flashing bubbles in full parallel configuration according to Embodiment II comprises:
a controller 61 configured to generate control signals and load the generated control signals onto power line 62 for output, three controllable flashing bubbles (615, 616, and 617), and 6 ordinary warm-white LEDs (618, 619, 620, 621, 622, and 623).

All 3 controllable flashing bubbles and 6 ordinary warm-white LEDs are connected in parallel.

The controller 61 in this Embodiment II includes an inverter circuit formed by a P-channel MOSFET CJ2301 611 and an N-channel MOSFET CJ2302 612. The source of CJ2301 611 is connected to 3.3V power input terminal 63; the drain of CJ2301 611 is connected to power line 62; the source of CJ2302 612 is connected to GND 64; the drain of CJ2302 612 is connected to power line 62; the gates of both CJ2301 611 and CJ2302 612 are connected to control output pin 614 of MCU 613.

The MCU 613 in this Embodiment II is an STC15F104E microcontroller. The control signals output by the microcontroller to control the switching (specifically, conduction and cutoff) of CJ2301 611 and CJ2302 612, thereby loading control signals onto power line 62. When control output pin 614 of MCU 613 outputs a low level, power line 62 is at high level; when control output pin 614 of MCU 613 outputs a high level, power line 62 is at low level. In this Embodiment II, by having MCU 613 output high or low levels through control output pin 614, pulse signals are loaded onto power line 62.

Structure of controllable flashing bubbles (615-617, see FIG. 7), comprises a driver chip 71 and a controlled warm-white LED 72. The power supply terminal of driver chip 71 and the anode of controlled warm-white LED 72 are connected in parallel to form the anode 73 of the controllable flashing bubble; the ground (GND) terminal of driver chip 71 serves as the cathode 74 of the controllable flashing bubble.

As shown in FIG. 7, the LED driver 71 includes an address memory 711 where an address code is stored, a pulse counting circuit 712, a drive circuit 713, and a state control circuit 714.

One frame of control signal includes an address signal and a color control signal. The address signal may be an address broadcast signal. When the controllable flashing bubble receives the address broadcast signal, it responds to the color control signal.

In some applications, the control signal includes an address broadcast signal and a color control signal; the control signal is transmitted cyclically at a given time period, and the total duration of low-level periods in the control signal determines the brightness of both the controllable flashing bubbles and the constant-on mode LEDs. The brightness of the controllable flashing bubbles and the constant-on mode LEDs is gradually decreased by progressively increasing the total duration of low-level periods in the control signal; or the brightness is gradually increased by progressively decreasing the total duration of low-level periods in the control signal.

In this Embodiment II, one frame of control signal includes a first group of pulse signals and a second group of pulse signals. The driver chip 71, controlled by the state control circuit 714, counts the number of pulses in the first group of pulse signals and the number of pulses in the second group of pulse signals. When the number of pulses in the first group of pulse signals is equal to the address code stored in the address memory 711 or when the address broadcast signal is received, the drive circuit 713 inverts the pulse counting result of the second group of pulse signals to drive the controlled warm-white LED 72. When the number of pulses in the first group is equal to the address code stored in the address memory 711 or when the address broadcast signal is received: if the number of pulses in the second group is 1, the controlled warm-white LED 72 turns on; if the number of pulses in the second group is 2, the controlled warm-white LED 72 turns off. In this embodiment, when the number of pulses in the first group of pulse signals in one frame of control signal is 4, all driver chips respond to the second group of pulse signals to correspondingly control the controlled warm-white LEDs. That is, when the number of pulses in the first group is 4, it serves as an address broadcast signal, and all controllable flashing bubbles respond to the second group of pulse signals to correspondingly control the controlled warm-white LEDs.

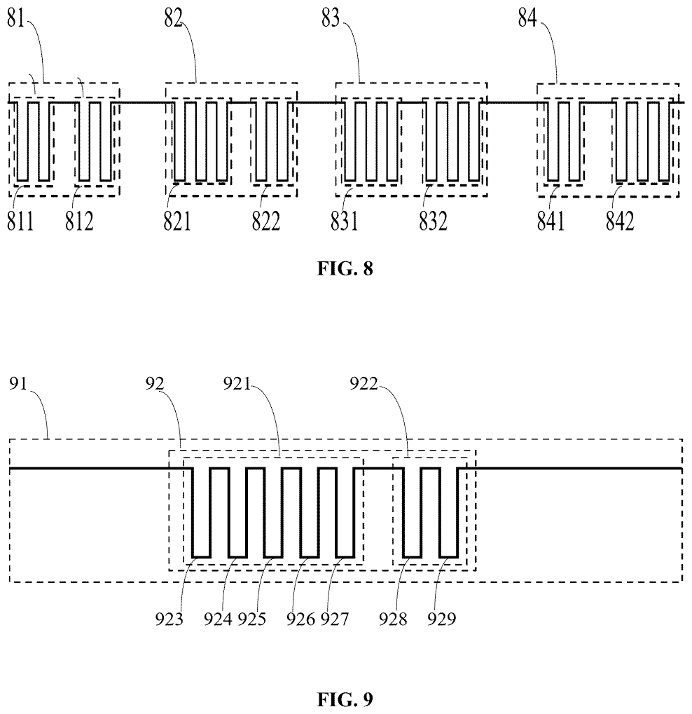

As shown in FIG. 8, taking the partial signal waveform diagram loaded by controller 61 of this Embodiment II on power line 62 as an example, the control method of this embodiment is explained, where the address code of controllable flashing bubble 615 equals 1, the address code of controllable flashing bubble 616 equals 2, and the address code of controllable flashing bubble 617 equals 3.

In this embodiment, 4 frames of control signals are transmitted, namely first frame control signal 81, second frame control signal 82, third frame control signal 83, and fourth frame control signal 84.

For the first frame control signal 81, the first group 811 contains 1 pulse, and the second group 812 contains 1 pulse, therefore, controllable flashing bubble 615 (address code=1) responds by illuminating warm white; for the second frame control signal 82, the first group 821 contains 2 pulses, and the second group 822 contains 1 pulse, therefore, controllable flashing bubble 616 (address code=2) responds by illuminating warm white; for the third frame control signal 83, the first group 831 contains 2 pulses, and the second group 832 contains 2 pulses, therefore, controllable flashing bubble 616 (address code=2) responds by extinguishing warm white; for the fourth frame control signal 84, the first group 841 contains 1 pulse, the second group 842 contains 2 pulses, therefore, controllable flashing bubble 616 (address code=2) responds by extinguishing warm white.

In some applications, the interval time between first frame control signal 81 and second frame control signal 82 can be adjusted to control the illumination interval between the controllable flashing bubble 615 (address code=1) and the controllable flashing bubble 616 (address code=2). The interval time between second frame control signal 82 and third frame control signal 83 can be adjusted to control the transition time for the controllable flashing bubble 616 (address code=2) changing from illuminated warm white to extinguished warm white.

In practice, it should be understood that by controlling each frame of control signals and adjusting the intervals between them, various lighting effects can be achieved in the final product.

Further, as shown in FIG. 9, with time period 91 as the cycle, a frame control signal 92 is continuously transmitted in cycles, where the first group 921 contains 4 pulses (address broadcast signal), the second group 922 contains 1 pulse. The total low-level duration in control signal 92 (sum of low-level periods 923, 924, 925, 926, 927, 928, and 929) determines the brightness of 3 controllable flashing bubbles (615, 616, 617), and 6 standard warm-white LEDs (618, 619, 620, 621, 622, 623).

Increasing the total low-level duration in control signal 92, the brightness of the 3 controllable flashing bubbles and 6 standard warm-white LEDs are reduced.

Gradually increasing the total low-level duration, the brightness of the 3 controllable flashing bubbles and 6 standard warm-white LEDs are gradually decreased.

Gradually decreasing the total low-level duration, the brightness of the 3 controllable flashing bubbles and 6 standard warm-white LEDs are gradually increased.

The increase or decrease of the total low-level duration in the control signal can be achieved by either: simultaneously increasing/decreasing all low-level pulse widths, or selectively increasing/decreasing partial low-level pulse widths.

By interspersing controllable flashing bubbles among constant-on LEDs and having them receive control signals loaded by the controller at the power output terminals, this invention achieves an LED decorative light whose flashing functions or patterns can be controlled by the controller.

The above describes preferred embodiments of the invention and should not be construed as limiting its scope. Any modifications, equivalent replacements, or improvements made within the spirit and principles of this invention shall fall within the scope of protection claimed by the invention.

1. An LED decorative light with controllable flashing bubbles, wherein the LED decorative light comprises:
a controller and a light string;
a positive terminal and a negative terminal of the controller are connected to the light string, wherein the controller supplies power to the light string through the positive terminal and the negative terminal, and loads control signals on the positive terminal and/or the negative terminal;
the light string comprises a plurality of LEDs and a plurality of controllable flashing bubbles, with the plurality of LEDs and the plurality of controllable flashing bubbles being in the same current path;
the controllable flashing bubbles receive the control signals to achieve controllable flashing effects.

2. The LED decorative light of claim 1, the controllable flashing bubble comprises:
a driver chip and a controlled LED, wherein the driver chip receives the control signal and controls the controlled LED to achieve the controllable flashing effect.

3. The LED decorative light of claim 2, wherein:
the driver chip performs an operation triggered by the control signal and drives the controlled LED based on the operation result.

4. The LED decorative light of claim 3, wherein:
the plurality of LEDs operates in a constant-on mode.

5. The LED decorative light of claim 4, wherein:
the control signal includes an address signal, and the driver chip receives the address signal and compares it with its own address code; when the received address signal matches the driver chip's address code, the driver chip executes the control signal.

6. The LED decorative light of claim 5, wherein:
the operation is an arithmetic operation, a logical operation, or a combination of arithmetic and logical operations.

7. The LED decorative light of claim 5, wherein:
the driver chip performs a pulse-counting operation based on the control signal.

8. The LED decorative light of claim 5, wherein:
the driver chip performs encoding or decoding operations on the control signal, wherein the pulse width (high or low level duration) of the control signal corresponds to encoded information.

9. The LED decorative light of claim 8, wherein:
the encoded information is represented by different high-level durations, different low-level durations, or a combination of different high-level durations and different low-level durations in the control signal.

10. The LED decorative light of claim 5, wherein:
the driver chip performs modulation or demodulation operations based on current or voltage frequency, and drives the controlled LED according to the modulation or demodulation results.

11. The LED decorative light of claim 5, wherein:
the controller comprises a controllable switch module, and the control signal is loaded via the controllable switch module.

12. The LED decorative light of claim 11, wherein:
the controllable switch module comprises a first controllable switch and an intermediate voltage module; when the first controllable switch is turned off, the intermediate voltage module generates a second voltage level, and the control signal is loaded by switching between the power supply voltage level and the second voltage level.

13. The LED decorative light of claim 11, wherein:
the control signal is loaded by controlling the turn-on and turn-off of the controllable switch module.

14. The LED decorative light of claim 11, wherein:
the controllable switch module is a first controllable switch, and the control signal is loaded by controlling the turn-on and turn-off of the first controllable switch.

15. The LED decorative light of claim 11, wherein:
the controllable switch module comprises:
a second controllable switch, a third controllable switch, and a current-limiting resistor;
the second controllable switch comprises a control terminal electrically connected to the control circuit, an input terminal serving as the input of the switch module, and an output terminal connected to ground;
the third controllable switch comprises a control terminal electrically connected to the control circuit, and an output terminal connected to ground;
the current-limiting resistor connects between the input terminal of the second controllable switch, and the input terminal of the third controllable switch.

16. The LED decorative light of claim 4, wherein:
the plurality of LEDs are ordinary light-emitting diodes without built-in driver chips.

17. The LED decorative light of claim 4, wherein:
the control signal includes an address broadcast signal and a color control signal;
the control signal is transmitted cyclically at a given time period, and the total duration of low-level periods in the control signal determines the brightness of both the controllable flashing bubbles and the constant-on mode LEDs.

18. The LED decorative light of claim 17, wherein:
the brightness of the controllable flashing bubbles and the constant-on mode LEDs is gradually decreased by progressively increasing the total duration of low-level periods in the control signal;
or the brightness is gradually increased by progressively decreasing the total duration of low-level periods in the control signal.
